(19) United States
(12) Patent Application Publication
(10) Pub. No.: US 2026/0353314 A1
(43) Pub. Date: Nov. 5, 2026

(54) COMMUNICATION PROCESSING METHOD AND APPARATUS, DEVICE, AND READABLE STORAGE MEDIUM

(71) Applicant: VIVO MOBILE COMMUNICATION CO., LTD., Dongguan (CN)

(72) Inventor: Li CHEN, Dongguan (CN)

(73) Assignee: VIVO MOBILE COMMUNICATION CO., LTD., Dongguan (CN)

(21) Appl. No.: 19/713,350

(22) Filed: Jun. 18, 2026

Related U.S. Application Data
(63) Continuation of application No. PCT/CN2024/139446, filed on Dec. 16, 2024.

(30) Foreign Application Priority Data
Dec. 21, 2023 (CN) 202311782617.9

(51) Int. Cl. H04W 56/00; H04W 28/02; H04W 76/20

(52) U.S. Cl. CPC H04W 56/0005; H04W 28/0268; H04W 28/0273; H04W 76/20

(57) ABSTRACT

This application discloses a communication processing method and apparatus, a device, and a readable storage medium. The method includes: receiving, by a first element, first information from a second element, where the first information is related to coordination or synchronization between streams; and performing, by the first element, a first operation based on the first information; where the first element is a first node and the second element is a second node, or the first element is a first entity and the second element is a second entity.

### CROSS-REFERENCE TO RELATED APPLICATIONS

This application is a continuation application of PCT International Application No. PCT/CN2024/139446 filed on Dec. 16, 2024, which claims priority to the Chinese Patent Application No. 202311782617.9 filed on Dec. 21, 2023, which is incorporated herein by reference in its entirety.

### TECHNICAL FIELD

This application pertains to the field of communication technologies, and specifically to a communication processing method and apparatus, a device, and a readable storage medium.

### BACKGROUND

Existing extended reality (XR) or cloud gaming (CG) services include multiple packets or multiple streams. Since the quality of service (QoS) requirements and operations between the various packets or streams are independent, problems such as stuttering, dizziness, and incoordination between images or audio may occur in the XR or CG services, affecting user service experience.

### SUMMARY

Embodiments of this application provide a communication processing method and apparatus, a device, and a readable storage medium.

According to a first aspect, a communication processing method is provided, including:
receiving, by a first element, first information from a second element, where the first information is related to coordination or synchronization between streams; and
performing, by the first element, a first operation based on the first information; where
the first element is a first node and the second element is a second node, or the first element is a first entity and the second element is a second entity.

According to a second aspect, a communication processing method is provided, including:
sending, by a second element, first information to a first element, wherethe first information is related to coordination or synchronization between streams; where
the first information is used for the first element to perform a first operation; where
the first element is a first node and the second element is a second node, or the first element is a first entity and the second element is a second entity.

According to a third aspect, a communication processing apparatus is provided, applied to a first element and including:
a first receiving module, configured to receive first information from a second element, where the first information is related to coordination or synchronization between streams; and
a first processing module, configured to perform a first operation based on the first information; where
the first element is a first node and the second element is a second node, or the first element is a first entity and the second element is a second entity.

According to a fourth aspect, a communication processing apparatus is provided, applied to a second element and including:
a first sending module, configured to send first information to a first element, where the first information is related to coordination or synchronization between streams, and the first information is used for the first element to perform a first operation; where
the first element is a first node and the second element is a second node, or the first element is a first entity and the second element is a second entity.

According to a fifth aspect, a communication device is provided, including: a processor, a memory, and a program or instructions stored in the memory and executable on the processor, where when the program or the instructions are executed by the processor, the steps of the method described in the first aspect or the second aspect are implemented.

According to a sixth aspect, a readable storage medium is provided, where the readable storage medium stores a program or instructions, where when the program or the instructions are executed by a processor of a sending end, the steps of the method described in the first aspect are implemented, or when the program or the instructions are executed by a processor of a receiving end, the steps of the method described in the second aspect are implemented.

According to a seventh aspect, a chip is provided, where the chip includes a processor and a communication interface, the communication interface and the processor are coupled with each other, and the processor is configured to run a program or instructions to implement the steps of the method described in the first aspect or the second aspect.

According to an eighth aspect, a computer program/program product is provided, where the computer program/program product is stored in a non-transitory storage medium, and the program/program product is executed by at least one processor to implement the steps of the method described in the first aspect or the second aspect.

According to a ninth aspect, a communication system is provided, where the communication system includes a sending end and a receiving end, the sending end is configured to perform the steps of the method described in the first aspect, and the receiving end is configured to perform the steps of the method described in the second aspect.

### BRIEF DESCRIPTION OF DRAWINGS

FIG. 1 is a schematic diagram of an XR service;

FIG. 2 is a schematic diagram of an interaction and an operation in an XR service;

FIG. 3 is a schematic diagram of a 5G architecture;

FIG. 4 is a schematic diagram of an architecture of a wireless communication system according to an embodiment of this application;

FIG. 5 is a first flowchart of a communication processing method provided in an embodiment of this application;

FIG. 6 is a second flowchart of a communication processing method provided in an embodiment of this application;

FIG. 7 is a first schematic diagram of a communication processing apparatus provided in an embodiment of this application;

FIG. 8 is a second schematic diagram of a communication processing apparatus provided in an embodiment of this application;

FIG. 9 is a schematic diagram of a terminal provided in an embodiment of this application;

FIG. 10 is a schematic diagram of a network-side device provided in an embodiment of this application; and

FIG. 11 is a schematic diagram of a communication device provided in an embodiment of this application.

### DESCRIPTION OF EMBODIMENTS

The technical solutions in embodiments of this application will be clearly described below with reference to the accompanying drawings in the embodiments of this application. It is clear that the described embodiments are some, but not all, embodiments of this application. Based on the embodiments in this application, all other embodiments obtained by those of ordinary skill in the art shall fall within the protection scope of this application.

The terms "first", "second", and the like in this application are used to distinguish similar objects and are not necessarily used to describe a specific order or sequence. It should be understood that the terms used in this way can be interchanged as appropriate, so that the embodiments of this application can be implemented in sequences other than those illustrated or described herein. The objects distinguished by "first" and "second" are usually of one type, and a quantity of objects is not limited. For example, a first object may mean one first object or more first objects. In addition, the term "or" in this application indicates at least one of the connected objects. For example, "A or B" encompasses three scenarios: scenario one includes A but not B; scenario two includes B but not A; and scenario three includes both A and B. The character "/" generally indicates that associated objects are in an "or" relationship.

The term "indication" in this application may be a direct indication (or explicit indication) or an indirect indication (or implicit indication). The direct indication may be understood as that a sender explicitly informs a receiver of specific information, an operation to be executed, or a request result in a sent indication. The indirect indication may be understood as that a receiver determines corresponding information according to an indication sent by a sender, or performs judgment and determines an operation to be executed or a request result according to a judgment result.

It should be noted that the technologies described in the embodiments of this application are not limited to a long term evolution (LTE) or LTE-advanced (LTE-A) system, and may also be used in other wireless communication systems, such as code division multiple access (CDMA), time division multiple access (TDMA), frequency division multiple access (FDMA), orthogonal frequency division multiple access (OFDMA), single-carrier frequency division multiple access (SC-FDMA), and the like. The terms "system" and "network" in this application are often used interchangeably, and the described technologies may be used in above systems and radio technologies, as well as in other systems and radio technologies. The following description describes a new radio (NR) system for exemplary purposes, and NR terminology is used in most of the following description, but these technologies may also be applied to systems other than NR systems, such as 6^{th} generation (6G) communication systems.

To facilitate understanding of the embodiments of this application, the following technical points are first introduced below.

I. Extended reality (XR) service

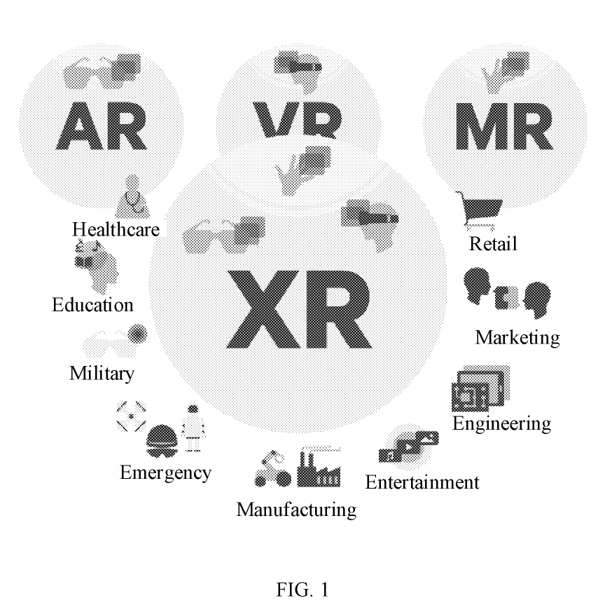

XR refers to all real and virtual combined environments and human-computer interactions generated by wearable devices using computer technologies. As shown in FIG. 1, representative forms of XR includes augmented reality (AR), mixed reality (MR), virtual reality (VR), and the like, as well as intersections between them. A virtual world ranges from partial sensory input to fully immersive virtual reality. A key aspect of XR is the extension of human experience, especially experiences related to sense of presence (represented by VR) and cognitive acquisition (represented by AR).

For VR services, an uplink is mainly for transmission of dense small data packets, where these small data packets may carry information such as gestures and control, serving as inputs and references for downlink presentation data; and a downlink is mainly for transmission of multimedia data such as video and audio. Through prompt receiving and presentation of the multimedia data, an immersive experience is provided to users. The downlink video data is used as an example. For periodical or quasi-periodical arrival of data packets, data rates may be up to tens or even hundreds of megabits per second (Mbps), a typical frame rate (frames per second, FPS) is 60 or 120, and an interval between adjacent data packets is approximately 1/FPS seconds. These data generally need to be transmitted over an air interface within 10 milliseconds (ms), and a transmission success rate is required to be not less than 99% or even 99.9%.

For AR services, in addition to the above transmission of dense small data packets on the uplink, multimedia data such as video and audio may also be transmitted, with service characteristics similar to those of the downlink, where data rates are usually relatively lower, for example, up to tens of Mbps, and an air interface transmission time may alternatively be less limited, for example, these data generally need to be transmitted within 60 ms. The downlink data transmission characteristics are basically consistent with VR services.

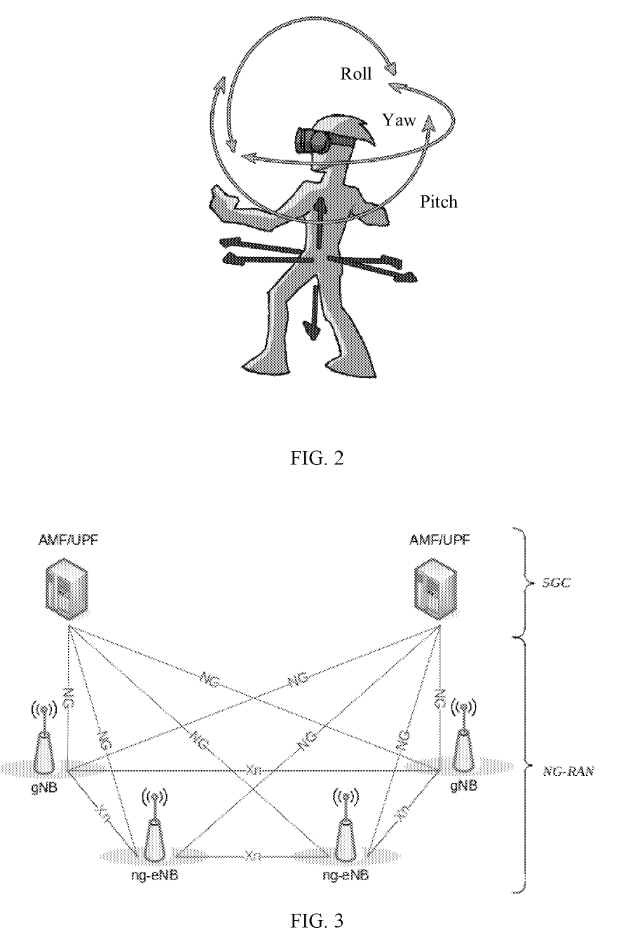

Since users want to perform interactions and operations in extended reality, as shown in FIG. 2, where actions and interactions include movements, gestures, and body responses, degrees of freedom (DoF) describes a quantity of independent parameters used to define viewport movement in 3D space.

In XR application scenarios, users can obtain information on new viewport angles through actions such as head turning during virtual reality experience. In this case, the head turning action of the XR user may be indicated to a base station by sending an uplink signal. After receiving the uplink signal, the base station schedules required downlink data for the XR user.

XR services mainly include video data, audio data, some control signaling with control functions, and special data. In a wireless network, XR service transmission mainly involves uplink and downlink transmission and interaction of video or audio data between a terminal (for example, user equipment (UE)) and a wireless communication network (for example, long term evolution (LTE), new radio (NR), or the like). When the UE transmits video and audio data, some control signaling with control functions and special data are transmitted on the uplink through the wireless network, to control generation, processing, and downlink wireless transmission of video and audio service data in the XR service sent by the network for the UE.

These control information with control functions and special data include some service control data generated by a UE XR application encoder and control data information included in a service transmission protocol. Exemplary control information and special data are as follows.

A. At the application layer, the following may be included, without limitation.
1. An I-frame or a non-field of view (non-FOV) frame generated by a video encoder.
2. User behavior data collected by a sensor, such as pose or control data. When receiving these data, the network can determine user behavior, for example, the above actions such as head turning of the user, and then adjust content of video data to be sent.

B. At a transmission protocol layer, the following may be included.
1. Transmission control protocol acknowledgment (TCP ACK) signaling (TCP feedback) for downlink audio or video service transmission. Based on whether a corresponding video or audio frame is acknowledged by the UE, the network determines whether a subsequent frame can be sent.
2. Real-time transport control protocol acknowledgment (RTCP ACK) signaling, a control signaling for control over real-time data transmission, confirming satisfaction of real-time requirements of service data transmission and time synchronization.

The network usually needs to receive the control signaling with control functions and special data from the UE in a timely and reliable manner, to obtain a transmission status of a current service and necessary related control information. An application server needs to further generate subsequent video and audio service data to be transmitted based on these information, and forward the data to the wireless network for processing and transmission, and the service data are finally sent to the UE on a downlink.

II. Packet data convergence protocol (PDCP) layer and radio bearer

Service data generated by the UE application layer are classified into different service data streams based on corresponding quality-of-service (QoS) requirements, and each service data stream corresponds to a same or similar QoS requirement. In the NR system, a service data stream corresponds to a QoS flow, while in the LTE system, a service data stream corresponds to an evolved packet system (EPS) bearer.

A piece of service data is delivered to an access stratum (AS) layer in a form of packet, and in the AS layer, further mapped to a radio bearer based on a corresponding QoS flow or EPS bearer. A radio bearer includes a PDCP entity, a radio link control (RLC) entity, and a corresponding logic channel (located at a medium access control (MAC) protocol layer).

After a packet delivered to the AS layer is mapped to a radio bearer, the packet is delivered to a corresponding PDCP entity for processing in a form of a PDCP service data unit (SDU). The PDCP entity generates a corresponding PDCP protocol data unit (PDU) for each arriving PDCP SDU, and set a PDCP sequence number (SN), indicating a transmission order of each PDCP SDU and a corresponding PDCP PDU in the PDCP entity. A value of the PDCP SN is set based on the order in which the PDCP SDU is delivered to the PDCP entity, with an earlier arriving PDCP SDU in an earlier position in the transmission order and a later delivered PDCP SDU in a later position. Specifically, the PDCP entity maintains an internal variable TX_NEXT that indicates a total number of PDCP PDUs transmitted by the PDCP entity and is used to set the value of the PDCP SN. When the PDCP entity is established, TX_NEXT is initialized to 0. Each time a PDCP SDU is delivered from an upper layer to a corresponding PDCP entity, the PDCP entity sets a SN of the PDCP PDU corresponding to the PDCP SDU to TX_NEXT, and adds 1 to TX_NEXT. Thereafter, the PDCP entity adds a header to each PDCP SDU to generate a corresponding PDCP PDU, which includes a SN value set for the PDCP PDU. The PDCP entity usually delivers the PDCP PDUs to the lower protocol layer (RLC) in sequence according to a sequence of the SNs included in the PDCP PDUs for subsequent processing and transmission, where the SN is an ordinal number, indicating a position of each PDCP SDU in a transmission sequence.

The general principle is that earlier arrival of a PDCP SDU at the PDCP entity means a smaller SN value and earlier transmission.

III. Fifth-generation (5G) mobile communication architecture

Refer to FIG. 3. A 5G system is formed by an access network (AN) and a fifth-generation mobile communication core network (5G Core Network, 5GC). If a non-standalone architecture (NSA) scenario is considered, it is also necessary to consider network elements in the fourth-generation (4G) mobile communication.

There are two types of ANs:
1. next generation NodeB (gNB), providing NR user plane and control plane protocol termination for a UE; and
2. new generation enhanced NodeB (ng-eNB), providing user plane and control plane protocol termination of evolved universal terrestrial radio access (E-UTRA) for a UE.

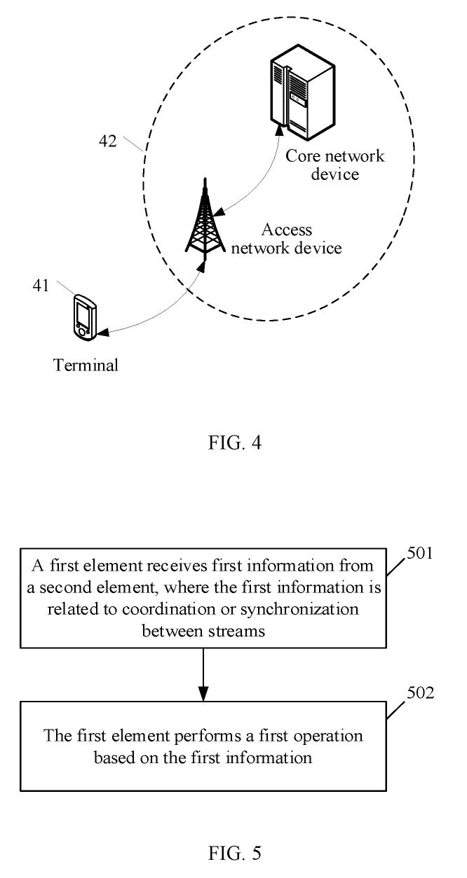

FIG. 4 is a block diagram of a wireless communication system to which an embodiment of this application can be applied. The wireless communication system includes a terminal 41 and a network-side device 42.

The terminal 41 may be a mobile phone, a tablet personal computer, a laptop computer, a notebook computer, a personal digital assistant (PDA), a handheld computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), a shipborne device, pedestrian user equipment (PUE), a smart home device (a home device with a wireless communication function, such as a refrigerator, television, washing machine, or furniture), a game console, a personal computer (PC), an automated teller machine or self-service machine, or another terminal-side device. The wearable device includes a smart watch, a smart bracelet, smart earphones, smart glasses, smart jewelry (a smart bangle, a smart bracelet, a smart ring, a smart necklace, a smart ankle bracelet, a smart anklet, and the like), a smart wristband, smart clothing, and the like. The vehicle user equipment may also be referred to as vehicle-mounted terminal, vehicle-mounted controller, vehicle-mounted module, vehicle-mounted component, vehicle-mounted chip, vehicle-mounted unit, or the like. In addition to the above terminal devices, the terminal involved in this application may also be a chip in the terminal, such as a modem chip or a system on chip (SoC). It should be noted that the specific type of the terminal 41 is not limited in the embodiments of this application.

The network-side device 42 may include an access network device or a core network device, where the access network device may also be referred to a radio access network device, a radio access network (RAN), a radio access network function, or a radio access network unit. The access network device may include a base station, a wireless local area network (WLAN), an access point (AP), a wireless fidelity (WiFi) node, and the like. The base station may be referred to as NodeB (NB), evolved NodeB (eNB), next generation NodeB (gNB), new radio NodeB (NR Node B), access point, relay base station (RBS), serving base station (SBS), base transceiver station (BTS), radio base station, radio transceiver, basic service set (BSS), extended service set (ESS), home NodeB (HNB), home evolved NodeB, transmission reception point (TRP), or another appropriate term in the field. As long as the same technical effects are achieved, the base station is not limited to specific technical terms. It should be noted that in the embodiments of this application, the base station in the NR system is taken as an example for description, and a specific type of the base station is not limited.

The core network device may include but is not limited to at least one of the following: core network node, core network function, mobility management entity (MME), access and mobility management function (AMF), session management function (SMF), user plane function (UPF), policy control function (PCF), policy and charging rules function (PCRF), edge application server discovery function (EASDF), unified data management (UDM), unified data repository (UDR), home subscriber server (HSS), centralized network configuration (CNC), network repository function (NRF), network exposure function (NEF), local NEF (L-NEF), binding support function (BSF), and the like. It should be noted that in the embodiments of this application, the core network device in the NR system is taken as an example for description, and a specific type of the core network device is not limited.

A communication processing method and apparatus, a communication device, and a readable storage medium provided in the embodiments of this application are described in detail below through some embodiments and their application scenarios with reference to the accompanying drawings.

Refer to FIG. 5. An embodiment of this application provides a communication processing method, specifically including: step 501 and step 502.

Step 501: A first element receives first information from a second element, where the first information is related to coordination or synchronization between streams.

Optionally, the first information may be information of synchronization requirement or coordination requirement.

Step 502: The first element performs a first operation based on the first information, where the first operation is used to ensure that a requirement for synchronization or coordination between streams or packets of the first element is satisfied.

In this application, satisfaction of per-packet or per-stream synchronization requirement can be understood as at least one of the following: a specific synchronization relationship is maintained between multiple packets or multiple streams at a receiving end, that is, the synchronization requirement is satisfied, for example, (1) multiple packets or multiple streams are received by the receiving end at similar times or at a same time; and (2) a specific synchronization relationship is maintained between multiple packets or multiple streams in a display buffer at the receiving end, that is, the synchronization requirement or coordination requirement is satisfied, for example, display buffer times of the multiple packets or multiple streams at the receiving end are similar, identical, or the like.

Satisfying the coordination requirement for the multiple packets or the multiple streams may be understood as at least one of the following: (1) through coordination, the multiple packets or the multiple streams are received by the receiving end at similar times or at a same time; and (2) through coordination, the display buffer times of the multiple packets or the multiple streams are similar or identical at the receiving end, thereby improving user service experience.

The first element is a first node and the second element is a second node, or the first element is a first entity and the second element is a second entity.

In an implementation of this application, the performing a first operation includes at least one of the following:
1. mapping a stream to a corresponding quality of service flow (QoS flow); where
   specifically, satisfaction of a synchronization requirement or a coordination requirement for different streams or different packets is achieved through control of mapping the stream to a QoS flow;
2. mapping a stream or a QoS flow to a corresponding data radio bearer (DRB); where
   specifically, satisfaction of a synchronization requirement or a coordination requirement for different streams or different packets is achieved through control of mapping the stream or the QoS flow to a DRB;
3. mapping a stream or a QoS flow or a DRB to a corresponding radio bearer; where
   specifically, satisfaction of a synchronization requirement or a coordination requirement between different streams or packets of different streams is achieved through control of mapping the stream or the QoS flow or the DRB to a bearer;
4. mapping a stream or a QoS flow or a DRB or a bearer to a corresponding logic channel group (LCG); where
   specifically, satisfaction of a synchronization requirement or a coordination requirement between different streams or packets of different streams is achieved through control of mapping the stream or the QoS flow or the DRB or bearer to an LCG;
5. mapping a stream or a QoS flow or a DRB or a bearer to a corresponding logic channel prioritization (LCP); where
   specifically, satisfaction of a synchronization requirement or a coordination requirement for different streams or packets of different streams is achieved through control of mapping the stream or the QoS flow or the DRB or the bearer to an LCP;
6. mapping a stream or a QoS flow or a DRB or a bearer to a corresponding logic channel (LCH); where
   for example, satisfaction of a synchronization requirement or a coordination requirement for different streams or packets of different streams is achieved through control of mapping the stream or the QoS flow or the DRB or the bearer to an LCH; and
7. applying a corresponding discard timer (discardTimer); where
   specifically, satisfaction of a synchronization requirement or a coordination requirement for different streams or packets of different streams is achieved through control over setting of different discardTimers for different packets or packets of different streams.

Satisfaction of the synchronization requirement between packets means that a delay difference between multiple packets is less than or equal to a first preset threshold.

Optionally, the delay difference includes one of the following: a latency, a delay gap, and a difference.

Optionally, a value of the first preset threshold may be protocol-defined, or configured by a server, a core network, a base station, an application layer, or the like.

Optionally, the delay difference between multiple packets includes at least one of the following:
1. a reception delay difference of multiple packets at the receiving end; where
   if the reception delay difference of multiple packets at the receiving end is less than or equal to the first preset threshold, it indicates that the synchronization requirement or the coordination requirement for the multiple packets is satisfied, avoiding problems of stuttering, dizziness, or incoordination between images or audio caused by asynchrony of multiple packets, thereby improving user service experience;
2. sending delay difference of multiple packets at the sending end; where
   if the sending delay difference of multiple packets at the sending end is less than or equal to the first preset threshold, it indicates that the synchronization requirement or the coordination requirement for the multiple packets is satisfied, avoiding problems of stuttering, dizziness, or incoordination between images or audio caused by asynchrony of multiple packets, thereby improving user service experience;
3. a delay difference between reception of one or more packets at the receiving end and sending of another packet at the sending end; where
   if the delay difference between reception of one or more packets at the receiving end and sending of another packet at the sending end is less than or equal to the first preset threshold, it indicates that the synchronization requirement or the coordination requirement for the one or more packets and the another packet is satisfied, avoiding problems of stuttering, dizziness, or incoordination between images or audio caused by asynchrony of multiple packets, thereby improving user service experience;
4. a delay difference between sending of one or more packets at the sending end and reception of another packet at the receiving end; where
   if the delay difference between sending of one or more packets at the sending end and reception of another packet at the receiving end is less than or equal to the first preset threshold, it indicates that the synchronization requirement or the coordination requirement for the one or more packets and the another packet is satisfied, avoiding problems of stuttering, dizziness, or incoordination between images or audio caused by asynchrony of multiple packets, thereby improving user service experience;
5. a delay difference of multiple packets in a display buffer; where
   if the delay difference of multiple packets in the display buffer is less than or equal to the first preset threshold, it indicates that the synchronization requirement or the coordination requirement for the multiple packets is satisfied, avoiding problems of stuttering, dizziness, or incoordination between images or audio caused by asynchrony of multiple packets, thereby improving user service experience; and
6. a delay difference of arrivals of multiple packets at the display buffer; where
   if the delay difference of the arrivals of multiple packets at the display buffer is less than or equal to the first preset threshold, it indicates that the synchronization requirement or the coordination requirement for the multiple packets is satisfied, avoiding problems of stuttering, dizziness, or incoordination between images or audio caused by asynchrony of multiple packets, thereby improving user service experience.

The synchronization requirement between streams means that the delay difference between multiple streams is less than a second preset threshold.

Optionally, the delay difference between the multiple streams includes at least one of the following:
1. a sending delay difference of multiple streams at the sending end; where
   if the sending delay difference of multiple streams at the sending end is less than or equal to the second preset threshold, it indicates that the synchronization requirement or the coordination requirement for the multiple streams is satisfied, avoiding problems of stuttering, dizziness, or incoordination between images or audio caused by asynchrony of multiple streams, thereby improving user service experience;
2. a delay difference between a reception delay of one or more streams at the receiving end and a sending delay of another stream at the sending end; where
   if the delay difference between a reception delay of one or more streams at the receiving end and a sending delay of another stream at the sending end is less than or equal to the second preset threshold, it indicates that the synchronization requirement or the coordination requirement for the one or more streams and the another stream is satisfied, avoiding problems of stuttering, dizziness, or incoordination between images or audio caused by asynchrony of multiple streams, thereby improving user service experience;
3. a delay difference between a sending delay of one or more streams at the sending end and a reception delay of another stream at the receiving end; where
   if the delay difference between the sending delay of one or more streams at the sending end and a reception delay of another stream at the receiving end is less than or equal to the second preset threshold, it indicates that the synchronization requirement or the coordination requirement for the one or more streams and the another stream is satisfied, avoiding problems of stuttering, dizziness, or incoordination between images or audio caused by asynchrony of multiple streams, thereby improving user service experience;
4. a delay difference of multiple streams in the display buffer; where
   if the delay difference of multiple streams in the display buffer is less than or equal to the second preset threshold, it indicates that the synchronization requirement or the coordination requirement for the multiple streams is satisfied, avoiding problems of stuttering, dizziness, or incoordination between images or audio caused by asynchrony of multiple streams, thereby improving user service experience;
5. a delay difference of arrivals of multiple streams at the display buffer; where
   if the delay difference of the arrivals of the multiple streams at the display buffer is less than or equal to the second preset threshold, it indicates that the synchronization requirement or the coordination requirement for the multiple streams is satisfied, avoiding problems of stuttering, dizziness, or incoordination between images or audio caused by asynchrony of multiple streams, thereby improving user service experience; and
6. a reception delay difference of multiple streams at the receiving end; where
   if the delay difference of the arrivals of the multiple streams at the display buffer is less than or equal to the second preset threshold, it indicates that the synchronization requirement or the coordination requirement for the multiple streams is satisfied, avoiding problems of stuttering, dizziness, or incoordination between images or audio caused by asynchrony of multiple streams, thereby improving user service experience.

Specifically, within a preset window or period or interval, an average delay of preset packets in a same stream is calculated, and the delay difference between two or more streams is a difference of calculated average delays. It can be understood that an average delay of preset packets in a same stream calculated within a preset window or period or interval can represent service rates or traveling speeds of two or more streams, and the delay difference being less than the second preset threshold indicates that the service rates or traveling speeds of the two or more streams are similar.

The average delay includes at least one of the following:
1. an average reception delay of multiple streams at the receiving end;
2. an average sending delay of multiple streams at the sending end;
3. an average delay between reception of one or more streams at the receiving end and sending of another stream at the sending end;
4. an average delay between sending of one or more streams at the sending end and reception of another stream at the receiving end;
5. an average delay of multiple streams in the display buffer; and
6. an average delay of arrivals of multiple streams at the display buffer.

In an implementation of this application, that a first element receives first information from a second element includes:
in a case that a first condition is satisfied, the first element receives the first information from the second element; where
the first condition includes at least one of the following:
   1. a first requirement is not satisfied between packets or streams; where
      it can be understood that "between packets" indicates multiple packets, and "between streams" indicates multiple streams, where "multiple packets" means two or more packets, and "multiple streams" means two or more streams;
   2. a second requirement is not satisfied between two nodes or two entities;
   3. a third requirement is not satisfied between packets or streams of two nodes, or between packets or streams of two entities; and
   4. a delay difference between packets or streams is greater than or equal to a first threshold.

It can be understood that when the delay difference between packets or streams is less than the first threshold, the first requirement is satisfied between the packets or streams. The delay difference between packets or streams includes at least one of the following: a delay difference of sending times between packets or streams, a delay difference of reception times between packets or streams, a delay difference of arrivals at the display buffer between packets or streams, and a delay difference in the display buffer between packets or streams.

The first requirement or the second requirement or the third requirement includes at least one of the following: a synchronization requirement and a coordination requirement.

Optionally, the first threshold may be protocol-defined, or configured by a server, a core network, a base station, an application layer, or the like.

For example, non-satisfaction of the requirement for synchronization between packets or streams includes at least one of the following: (1) packets or streams do not have a specific synchronization relationship at the first element, that is, the synchronization requirement is not satisfied, for example, reception times of packets or streams at the first element are not identical; and (2) packets or streams do not have a specific synchronization relationship in the display buffer of the first element, that is, the synchronization requirement is not satisfied, for example, display buffer times of packets or streams at the first element are not identical.

For example, non-satisfaction of the requirement for coordination between packets or streams includes at least one of the following: (1) reception times of packets or streams at the first element are not identical, which means coordination is required to achieve similar or identical reception times; and (2) display buffer times of packets or streams at the first element are not identical, which means coordination is required to achieve similar or identical display buffer times.

For example, non-satisfaction of the requirement for synchronization between two nodes or two entities includes non-satisfaction of the requirement for synchronization between packets or streams of two nodes, or between packets or streams of two entities.

For example, non-satisfaction of the requirement for coordination between two nodes or two entities includes non-satisfaction of the requirement for coordination between packets or streams of two nodes, or between packets or streams of two entities.

In an implementation of this application, that the first element performs a first operation based on the first information includes:
in a case that a second condition is satisfied, the first element performs the first operation based on the first information; where
the second condition includes at least one of the following:
1. a fourth requirement is not satisfied between packets or streams;
2. a fifth requirement is not satisfied between two nodes or two entities;
3. a sixth requirement is not satisfied between packets or streams of two nodes, or between packets or streams of two entities; and
4. a delay difference between packets or streams is greater than or equal to a second threshold; where
   the fourth requirement or the fifth requirement or the sixth requirement includes at least one of the following: a synchronization requirement and a coordination requirement.

Optionally, the second threshold may be protocol-defined, or configured by a server, a core network, a base station, an application layer, or the like.

In an implementation of this application, that the first element receives the first information from the second element includes at least one of the following:
1. a first node directly receives the first information from a second node; and
2. the first node receives the first information from the second node through a third node.

In an implementation of this application, that the first element receives the first information from the second element includes at least one of the following:
1. a first entity directly receives the first information from a second entity; and
2. the first entity receives the first information from the second entity through a third entity.

In an implementation of this application, the first node and the second node include at least one of the following:
1. two nodes having a synchronization requirement or a coordination requirement; and
2. two nodes which two objects having a synchronization requirement or a coordination requirement are located in or belong to.

In an implementation of this application, the first entity and the second entity include at least one of the following:
1. two entities having a synchronization requirement or a coordination requirement; and
2. two entities for two objects having a synchronization requirement or a coordination requirement, where the two objects are located in, or mapped to, or correspond to the two entities.

In an implementation of this application, the object includes at least one of the following: a service stream, a protocol data unit (PDU) session, a bearer, a stream, a QoS flow, a DRB, a radio link control (RLC) bearer, an LCG, an LCH, a PDU set, a PDU, and a packet.

In an implementation of this application, the first entity and the second entity correspond to a same node, or the first entity and the second entity correspond to different nodes.

Optionally, the first entity and the second entity are two entities of a same terminal, for example, two entities of a same terminal interact with each other for exchange of first information.

Optionally, the first entity and the second entity are two entities corresponding to two terminals respectively. For example, two entities of different terminals interact with each other for exchange of first information.

In an implementation of this application, the first information includes at least one of the following:
1. whether a seventh requirement is satisfied between packets or streams or nodes or entities;
2. synchronization or coordination object information;
3. a synchronization indicator or a coordination indicator;
4. a synchronization requirement; where
   optionally, the synchronization requirement is used to indicate that a packet or a stream needs to be transmitted and processed according to a specific time relationship; and
5. coordination requirement; where
   optionally, the coordination requirement is used to indicate that a packet or a stream is sent and processed according to a specific order, timing, or condition, to ensure continuity, effectiveness, and correctness of communication;
6. a time label or a timestamp; where
   the time label or the timestamp is used to indicate time information of a corresponding packet or stream or node or entity;
7. a synchronization requirement between packets; where
   optionally, the packet coordination requirement is used to ensure that data packets are transmitted and processed in a predefined, cooperative manner;
8. a synchronization requirement between streams; where
   optionally, the stream coordination requirement is used to ensure that data streams are transmitted and processed in a predefined, cooperative manner;
9. a delay requirement for packets that have an association relationship or an eighth requirement; where
   the packets having an association relationship refer to packets having a dependency or sequential requirement; and
   optionally, the delay requirement is used to indicate a maximum time delay allowed for transmission from a source to a destination; and
10. a delay requirement for streams that have an association relationship or a ninth requirement; where
   the streams having an association relationship refer to streams having a dependency or sequential requirement; and
   the seventh requirement or the eighth requirement or the ninth requirement includes at least one of a synchronization requirement and coordination requirement.
In an implementation of this application, whether a synchronization requirement is satisfied between packets includes: whether a delay difference between the packets is less than or equal to a third threshold;
or
whether a synchronization requirement is satisfied between streams includes: whether a delay difference between the streams is less than or equal to a fourth threshold.

Optionally, the third threshold or fourth threshold may be protocol-defined, or configured by a server, a core network, a base station, an application layer, or the like.

In an implementation of this application, the node includes at least one of the following: a terminal, a user, and a network-side node (for example, a server).

In an implementation of this application, in a case that the first node is a first terminal and the second node is a second terminal, or the first node is a first client and the second node is a second client, the third node includes at least one of the following: a terminal or a client other than the first node and the second node, a network-side node, and a server.

Optionally, the network-side node includes but is not limited to at least one of a base station, an access and mobility management function (AMF), and a user plane function (UPF).

In an implementation of this application, in a case that the first node is a first network-side node and the second node is a second network-side node, the third node includes at least one of the following: a network-side node other than the first node and the second node, a terminal, and a server.

In an implementation of this application, the entity includes at least one of the following: a service data adaptation protocol (SDAP) entity, a packet data convergence protocol (PDCP) entity, an RLC entity, a medium access control (MAC) entity, and a physical (PHY) layer entity.

Coordination and synchronization requirements of PDCP entities are used as examples. Two PDCP entities of a same terminal interact with each other for exchange of first information, further, two SDAP entities of a same terminal interact with each other for exchange of first information. As another example, two PDCP entities of different terminals interact with each other for exchange of first information, further, two SDAP entities of different terminals interact with each other for exchange of first information. The PDCP entity performs at least one of the following based on the first information: mapping a stream or a packet having a synchronization requirement to a corresponding bearer; and mapping a stream or packet satisfying a second condition to a corresponding bearer.

Coordination and synchronization requirements between terminals are used as an example. In a case that a first condition is satisfied, a first terminal (that is, a first node) receives first information from a second terminal (that is, a second node), and in a case that a second condition is satisfied, the first terminal performs a first operation based on the first information. Optionally, the first terminal or the second terminal sends the first information to a network-side node, further, in a case that a third condition is satisfied, the first terminal or the second terminal sends the first information to a network-side node, where the third condition may be the same as or different from the first condition or second condition.

In an implementation of this application, in a case that the first entity is a first SDAP entity and the second entity is a second SDAP entity, the third entity includes at least one of the following: a PDCP entity and a radio resource control (RRC) entity.

In an implementation of this application, in a case that the first entity is a first PDCP entity and the second entity is a second PDCP entity, the third entity includes at least one of the following: an SDAP entity, an RLC entity, a MAC entity, and an RRC entity.

In an implementation of this application, in a case that the first entity is a first RLC entity and the second entity is a second RLC entity, the third entity includes at least one of the following: an SDAP entity, a PDCP entity, a MAC entity, and an RRC entity.

In an implementation of this application, in a case that the first entity is a first MAC entity and the second entity is a second MAC entity, the third entity includes at least one of the following: a PDCP entity, an RLC entity, a PHY entity, and an RRC entity.

In an implementation of this application, the packet includes at least one of the following:
1. multiple packets of a same user;
2. multiple packets of different users; where
   for example, different users include different users under a same base station or cell or distributed unit (DU) or centralized unit (CU) or core network (CN) or radio access network (RAN) or public land mobile network (PLMN) or network, or different users under different base stations or cells or DUs or CUs or CNs or RANs or PLMNs or networks;
3. multiple packets of a same UE;
4. multiple packets of different UEs; where
   for example, different UEs include different UEs of a same user (for example, different UEs of a same user, including but not limited to at least one of the following: watch, glove, head-mounted display, helmet, glasses, mobile phone, and AR or VR device), or different UEs of different users;
5. multiple packets of a same stream;
6. multiple packets of different streams; where
   for example, different streams include different streams of a same UE, or different streams of different UEs;
7. multiple packets of a same QoS flow;
8. multiple packets of different QoS flows; where
   for example, different QoS flows include different QoS flows of a same UE, or different QoS flows of different UEs; or different QoS flows include different QoS flows of a same stream, or different QoS flows of different streams;
9. multiple packets of a same IP or user datagram protocol (UDP) packet;
10. multiple packets in different IP or UDP packets; where
   for example, different IP or UDP packets include different IP or UDP packets of a same UE or stream, or different IP or UDP packets of different UEs or streams;
11. multiple packets in a same burst;
12. multiple packets in different bursts; where
   for example, different bursts include different bursts of a same stream or a same IP or UDP packet or a same QoS flow, or different bursts of different streams or different IP or UDP packets or different QoS flows;
13. multiple packets in a same bearer;
14. multiple packets in different bearers;
15. multiple packets in a same PDU session;
16. multiple packets in different PDU sessions;
17. multiple packets in a same PDU set;
18. multiple packets in different PDU sets; where
   for example, different PDU sets include different PDU sets of a same stream or a same IP or UDP packet or a same QoS flow, or different PDU sets of different streams or different IP or UDP packets or different QoS flows;
19. multiple packets in a same PDU;
20. multiple packets in different PDUs;
21. multiple packets in a same data radio bearer (DRB);
22. multiple packets in different DRBs; where
   for example, different DRBs include different DRBs of a same stream or a same IP or UDP packet or a same QoS flow, or different DRBs of different streams or different IP or UDP packets or different QoS flows;
23. multiple packets in a same service; and
24. multiple packets in different services; where
   the above packet may be at least one of the following: a packet, a burst, a PDU set, a PDU, a service data unit (SDU), a DRB, and a transport block (TB).

The above packet may be at least one of the following: a burst, a PDU set, a PDU, an SDU, a DRB, and a TB. For example, one packet includes multiple bursts, one burst includes multiple PDU sets, and one PDU set includes multiple PDUs.

In the embodiments of this application, a first element receives first information from a second element, where the first information is related to coordination or synchronization between streams; and the first element performs a first operation based on the first information, so that a synchronization requirement or a coordination requirement is satisfied between packets or streams of the first element, avoiding problems of stuttering, dizziness, or incoordination between images or audio caused by asynchrony of streams or packets, thereby improving user service experience.

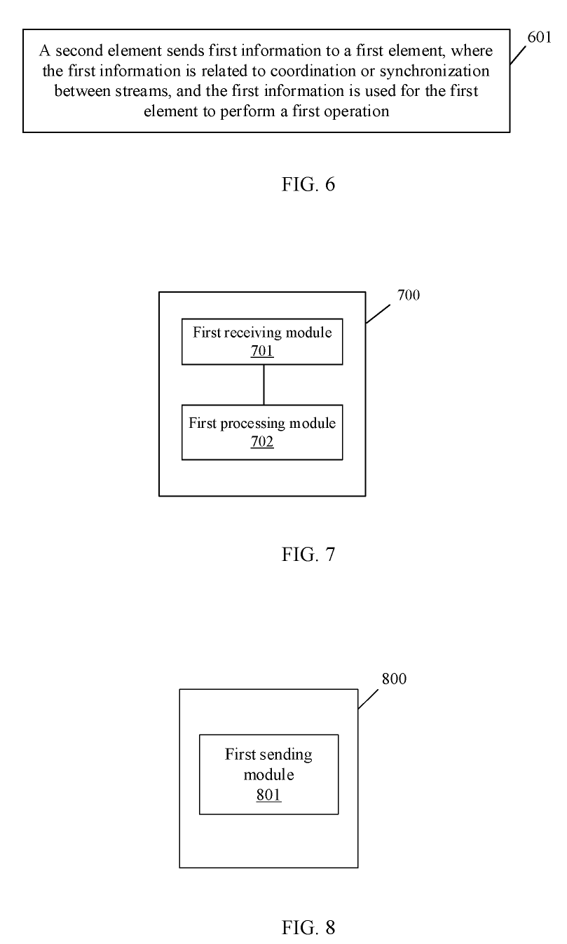

Refer to FIG. 6. An embodiment of this application provides a communication processing method, specifically including the following step.

Step 601: A second element sends first information to a first element, where the first information is related to coordination or synchronization between streams, and the first information is used for the first element to perform a first operation; where
the first element is a first node and the second element is a second node, or the first element is a first entity and the second element is a second entity.

In an implementation of this application, the performing the first operation includes at least one of the following:
1. mapping a stream to a corresponding QoS flow;
2. mapping a stream or a QoS flow to a corresponding DRB;
3. mapping a stream or a QoS flow or a DRB to a corresponding bearer;
4. mapping a stream or a QoS flow or a DRB or a bearer to a corresponding LCG;
5. mapping a stream or a QoS flow or a DRB or a bearer to a corresponding LCP;
6. mapping a stream or a QoS flow or a DRB or a bearer to a corresponding LCH; and
7. applying a corresponding discardTimer.

In an implementation of this application, that a second element sends first information to a first element includes:
in a case that a first condition is satisfied, the second element sends the first information to the first element; where
the first condition includes at least one of the following:
1. a first requirement is not satisfied between packets or streams;
2. a second requirement is not satisfied between two nodes or two entities;
3. a third requirement is not satisfied between packets or streams of two nodes, or between packets or streams of two entities; and
4. a delay difference between packets or streams is greater than or equal to a first threshold; where
the first requirement or the second requirement or the third requirement includes at least one of the following: a synchronization requirement and a coordination requirement.

In an implementation of this application, that a second element sends first information to a first element includes at least one of the following:
1. the second node directly sends the first information to the first node; and
2. the second node sends the first information to the first node through a third node.

In an implementation of this application, that a second element sends first information to a first element includes at least one of the following:
1. the second entity directly sends the first information to the first entity; and
2. the second entity sends the first information to the first entity through a third entity.

In an implementation of this application, the first node and the second node include at least one of the following:
1. two nodes having a synchronization requirement or a coordination requirement; and
2. two nodes which two objects having a synchronization requirement or a coordination requirement are located in or belong to.

In an implementation of this application, the first entity and the second entity include at least one of the following:
1. two entities having a synchronization requirement or a coordination requirement; and
2. two entities for two objects having a synchronization requirement or a coordination requirement, where the two objects are located in, or mapped to, or correspond to the two entities.

In an implementation of this application, the object includes at least one of the following: a service stream, a PDU session, a bearer, a stream, a QoS flow, a DRB, an RLC bearer, an LCG, an LCH, a PDU set, a PDU, and a packet.

In an implementation of this application, the first information includes at least one of the following:
1. whether a seventh requirement is satisfied between packets or streams or nodes or entities;
2. synchronization or coordination object information;
3. a synchronization indicator or a coordination indicator;
4. a synchronization requirement;
5. a coordination requirement;
6. a time label or a timestamp;
7. a synchronization requirement between packets;
8. a synchronization requirement between streams;
9. a delay requirement for packets that have an association relationship or an eighth requirement; and
10. a delay requirement for streams that have an association relationship or a ninth requirement; where
   the seventh requirement or the eighth requirement or the ninth requirement includes at least one of a synchronization requirement and a coordination requirement.

In an implementation of this application, the node includes at least one of the following: a terminal, a user, and a network-side node.

In an implementation of this application, in a case that the first node is a first terminal and the second node is a second terminal, or the first node is a first client and the second node is a second client, the third node includes at least one of the following: a terminal or a client other than the first node and the second node, a network-side node, and a server.

In an implementation of this application, in a case that the first node is a first network-side node and the second node is a second network-side node, the third node includes at least one of the following: a network-side node other than the first node and the second node, a terminal, and a server.

In an implementation of this application, the entity includes at least one of the following: an SDAP entity, a PDCP entity, an RLC entity, a MAC entity, and a PHY entity.

In an implementation of this application, in a case that the first entity is a first SDAP entity and the second entity is a second SDAP entity, the third entity includes at least one of the following: a PDCP entity, and an RRC entity.

In an implementation of this application, in a case that the first entity is a first PDCP entity and the second entity is a second PDCP entity, the third entity includes at least one of the following: an SDAP entity, an RLC entity, a MAC entity, and an RRC entity.

In an implementation of this application, in a case that the first entity is a first RLC entity and the second entity is a second RLC entity, the third entity includes at least one of the following: an SDAP entity, a PDCP entity, a MAC entity, and an RRC entity.

In an implementation of this application, in a case that the first entity is a first MAC entity and the second entity is a second MAC entity, the third entity includes at least one of the following: a PDCP entity, an RLC entity, a PHY entity, and an RRC entity.

In this embodiment of this application, the packet includes at least one of the following:
1. multiple packets of a same user;
2. multiple packets of different users;
3. multiple packets of a same UE;
4. multiple packets of different UEs;
5. multiple packets of a same stream;
6. multiple packets of different streams; where
   for example, different streams include different streams of a same UE, or different streams of different UEs;
7. multiple packets of a same QoS flow;
8. multiple packets of different QoS flows;
9. multiple packets in a same IP or UDP packet;
10. multiple packets in different IP or UDP packets;
11. multiple packets in a same burst;
12. multiple packets in different bursts;
13. multiple packets in a same bearer;
14. multiple packets in different bearers;
15. multiple packets in a same PDU session;
16. multiple packets in different PDU sessions;
17. multiple packets in a same PDU set;
18. multiple packets in different PDU sets;
19. multiple packets in a same PDU;
20. multiple packets in different PDUs;
21. multiple packets in a same DRB;
22. multiple packets in different DRBs;
23. multiple packets in a same service; and
24. multiple packets in different services.

In this embodiment of this application, a second element sends first information to a first element, where the first information is related to coordination or synchronization between streams, and the first information is used for the first element to perform a first operation, so that a synchronization requirement or a coordination requirement is satisfied between packets or streams of the first element, avoiding problems of stuttering, dizziness, or incoordination between images or audio caused by asynchrony of streams or packets, thereby improving user service experience.

Refer to FIG. 7. An embodiment of this application provides a communication processing apparatus, applied to a first element, where an apparatus 700 includes:
a first receiving module 701, configured to receive first information from a second element, where the first information is related to coordination or synchronization between streams; and
a first processing module 702, configured to perform a first operation based on the first information; where
the first element is a first node and the second element is a second node, or the first element is a first entity and the second element is a second entity.

In an implementation of this application, the performing a first operation includes at least one of the following:
1. mapping a stream to a corresponding QoS flow;
2. mapping a stream or a QoS flow to a corresponding DRB;
3. mapping a stream or a QoS flow or a DRB to a corresponding bearer;
4. mapping a stream or a QoS flow or a DRB or a bearer to a corresponding LCG;
5. mapping a stream or a QoS flow or a DRB or a bearer to a corresponding LCP;
6. mapping a stream or a QoS flow or a DRB or a bearer to a corresponding LCH; and
7. applying a corresponding discard timer.

In an implementation of this application, the first receiving module 701 is further configured to:
in a case that a first condition is satisfied, receive the first information from the second element; where
the first condition includes at least one of the following:
1. a first requirement is not satisfied between packets or streams;
2. a second requirement is not satisfied between two nodes or two entities;
3. a third requirement is not satisfied between packets or streams of two nodes, or between packets or streams of two entities; and
4. a delay difference between packets or streams is greater than or equal to a first threshold; where
   the first requirement or the second requirement or the third requirement includes at least one of the following: a synchronization requirement and a coordination requirement.

In an implementation of this application, the first processing module 702 is further configured to:
in a case that a second condition is satisfied, perform the first operation based on the first information; where
the second condition includes at least one of the following:
1. a fourth requirement is not satisfied between packets or streams;
2. a fifth requirement is not satisfied between two nodes or two entities;
3. a sixth requirement is not satisfied between packets or streams of two nodes, or between packets or streams of two entities; and
4. a delay difference between packets or streams is greater than or equal to a second threshold; where
   the fourth requirement or the fifth requirement or the sixth requirement includes at least one of the following: a synchronization requirement and a coordination requirement.

In an implementation of this application, the first receiving module 701 is further configured for at least one of the following: receiving the first information from the second node directly; and receiving the first information from the second node through a third node.

In an implementation of this application, the first receiving module 701 is further configured for at least one of the following: receiving the first information from the second entity directly; and receiving the first information from the second entity through a third entity.

In an implementation of this application, the first node and the second node include at least one of the following:
1. two nodes having a synchronization requirement or a coordination requirement; and
2. two nodes which two objects having a synchronization requirement or a coordination requirement are located in or belong to.

In an implementation of this application, the first entity and the second entity include at least one of the following:
1. two entities having a synchronization requirement or a coordination requirement; and
2. two entities for two objects having a synchronization requirement or a coordination requirement, where the two objects are located in, or mapped to, or correspond to the two entities.

In an implementation of this application, the object includes at least one of the following: a service stream, a PDU session, a bearer, a stream, a QoS flow, a DRB, an RLC bearer, an LCG, an LCH, a PDU set, a PDU, and a packet.

In an implementation of this application, the first entity and the second entity correspond to a same node, or the first entity and the second entity correspond to different nodes.

In an implementation of this application, the first information includes at least one of the following:
1. whether a seventh requirement is satisfied between packets or streams or nodes or entities;
2. synchronization or coordination object information;
3. a synchronization indicator or a coordination indicator;
4. a synchronization requirement;
5. a coordination requirement;
6. a time label or a timestamp;
7. a synchronization requirement between packets;
8. a synchronization requirement between streams;
9. a delay requirement for packets that have an association relationship or an eighth requirement; and
10. a delay requirement for streams that have an association relationship or a ninth requirement; where
   the seventh requirement or the eighth requirement or the ninth requirement includes at least one of a synchronization requirement and a coordination requirement.
In an implementation of this application, whether a synchronization requirement is satisfied between packets includes: whether a delay difference between the packets is less than or equal to a third threshold;
or
whether a synchronization requirement is satisfied between streams includes: whether a delay difference between the streams is less than or equal to a fourth threshold.

In an implementation of this application, the node includes at least one of the following: a terminal, a user, and a network-side node.

In an implementation of this application, in a case that the first node is a first terminal and the second node is a second terminal, or the first node is a first client and the second node is a second client, the third node includes at least one of the following: a terminal or a client other than the first node and the second node, a network-side node, and a server.

In an implementation of this application, in a case that the first node is a first network-side node and the second node is a second network-side node, the third node includes at least one of the following: a network-side node other than the first node and the second node, a terminal, and a server.

In an implementation of this application, the entity includes at least one of the following: an SDAP entity, a PDCP entity, an RLC entity, a MAC entity, and a PHY entity.

In an implementation of this application, in a case that the first entity is a first SDAP entity and the second entity is a second SDAP entity, the third entity includes at least one of the following: a PDCP entity and an RRC entity.

In an implementation of this application, in a case that the first entity is a first PDCP entity and the second entity is a second PDCP entity, the third entity includes at least one of the following: an SDAP entity, an RLC entity, a MAC entity, and an RRC entity.

In an implementation of this application, in a case that the first entity is a first RLC entity and the second entity is a second RLC entity, the third entity includes at least one of the following: an SDAP entity, a PDCP entity, a MAC entity, and an RRC entity.

In an implementation of this application, in a case that the first entity is a first MAC entity and the second entity is a second MAC entity, the third entity includes at least one of the following: a PDCP entity, an RLC entity, a PHY entity, and an RRC entity.

In this embodiment of this application, the packet includes at least one of the following:
1. multiple packets of a same user;
2. multiple packets of different users;
3. multiple packets of a same UE;
4. multiple packets of different UEs;
5. multiple packets of a same stream;
6. multiple packets of different streams; where
   for example, different streams include different streams of a same UE, or different streams of different UEs;
7. multiple packets of a same QoS flow;
8. multiple packets of different QoS flows;
9. multiple packets in a same IP or UDP packet;
10. multiple packets in different IP or UDP packets;
11. multiple packets in a same burst;
12. multiple packets in different bursts;
13. multiple packets in a same bearer;
14. multiple packets in different bearers;
15. multiple packets in a same PDU session;
16. multiple packets in different PDU sessions;
17. multiple packets in a same PDU set;
18. multiple packets in different PDU sets;
19. multiple packets in a same PDU;
20. multiple packets in different PDUs;
21. multiple packets in a same DRB;
22. multiple packets in different DRBs;
23. multiple packets in a same service; and
24. multiple packets in different services.

The apparatus provided in this embodiment of this application can implement the processes implemented by the method embodiment in FIG. 5, with the same technical effects achieved. To avoid repetition, details are not described herein.

Refer to FIG. 8. An embodiment of this application provides a communication processing apparatus, applied to a second element, where an apparatus 800 includes:
a first sending module 801, configured to send first information to a first element, where the first information is related to coordination or synchronization between streams, and the first information is used for the first element to perform a first operation; where
the first element is a first node and the second element is a second node, or the first element is a first entity and the second element is a second entity.

In an implementation of this application, the performing a first operation includes at least one of the following:
1. mapping a stream to a corresponding QoS flow;
2. mapping a stream or a QoS flow to a corresponding DRB;
3. mapping a stream or a QoS flow or a DRB to a corresponding bearer;
4. mapping a stream or a QoS flow or a DRB or a bearer to a corresponding LCG;
5. mapping a stream or a QoS flow or a DRB or a bearer to a corresponding LCP;
6. mapping a stream or a QoS flow or a DRB or a bearer to a corresponding LCH; and
7. applying a corresponding discardTimer.

In an implementation of this application, the first sending module 801 is further configured to:
in a case that a first condition is satisfied, send the first information to the first element; where
the first condition includes at least one of the following:
1. a first requirement is not satisfied between packets or streams;
2. a second requirement is not satisfied between two nodes or two entities;
3. a third requirement is not satisfied between packets or streams of two nodes, or between packets or streams of two entities; and
4. a delay difference between packets or streams is greater than or equal to a first threshold; where
   the first requirement or the second requirement or the third requirement includes at least one of the following: a synchronization requirement and a coordination requirement.

In an implementation of this application, the first sending module 801 is further configured for at least one of the following: sending the first information to the first node directly; and sending the first information to the first node through a third node.

In an implementation of this application, the first sending module 801 is further configured for at least one of the following: sending the first information to the first entity directly; and sending the first information to the first entity through a third entity.

In an implementation of this application, the first node and the second node include at least one of the following:
1. two nodes having a synchronization requirement or a coordination requirement; and
2. two nodes which two objects having a synchronization requirement or a coordination requirement are located in or belong to.

In an implementation of this application, the first entity and the second entity include at least one of the following:
1. two entities having a synchronization requirement or a coordination requirement; and
2. two entities for two objects having a synchronization requirement or a coordination requirement, where the two objects are located in, or mapped to, or correspond to the two entities.

In an implementation of this application, the object includes at least one of the following: a service stream, a PDU session, a bearer, a stream, a QoS flow, a DRB, an RLC bearer, an LCG, an LCH, a PDU set, a PDU, and a packet.

In an implementation of this application, the first information includes at least one of the following:
1. whether a seventh requirement is satisfied between packets or streams or nodes or entities;
2. synchronization or coordination object information;
3. a synchronization indicator or a coordination indicator;
4. a synchronization requirement;
5. a coordination requirement;
6. a time label or a timestamp;
7. a synchronization requirement between packets;
8. a synchronization requirement between streams;
9. a delay requirement for packets that have an association relationship or an eighth requirement; and
10. a delay requirement for streams that have an association relationship or a ninth requirement; where
   the seventh requirement or the eighth requirement or the ninth requirement includes at least one of a synchronization requirement and a coordination requirement.

In an implementation of this application, the node includes at least one of the following: a terminal, a user, and a network-side node.

In an implementation of this application, in a case that the first node is a first terminal and the second node is a second terminal, or the first node is a first client and the second node is a second client, the third node includes at least one of the following: a terminal or a client other than the first node and the second node, a network-side node, and a server.

In an implementation of this application, in a case that the first node is a first network-side node and the second node is a second network-side node, the third node includes at least one of the following: a network-side node other than the first node and the second node, a terminal, and a server.

In an implementation of this application, the entity includes at least one of the following: an SDAP entity, a PDCP entity, an RLC entity, a MAC entity, and a PHY entity.

In an implementation of this application, in a case that the first entity is a first SDAP entity and the second entity is a second SDAP entity, the third entity includes at least one of the following: a PDCP entity and an RRC entity.

In an implementation of this application, in a case that the first entity is a first PDCP entity and the second entity is a second PDCP entity, the third entity includes at least one of the following: an SDAP entity, an RLC entity, a MAC entity, and an RRC entity.

In an implementation of this application, in a case that the first entity is a first RLC entity and the second entity is a second RLC entity, the third entity includes at least one of the following: an SDAP entity, a PDCP entity, a MAC entity, and an RRC entity.

In an implementation of this application, in a case that the first entity is a first MAC entity and the second entity is a second MAC entity, the third entity includes at least one of the following: a PDCP entity, an RLC entity, a PHY entity, and an RRC entity.

In this embodiment of this application, the multiple packets include at least one of the following:
1. multiple packets of a same user;
2. multiple packets of different users;
3. multiple packets of a same UE;
4. multiple packets of different UEs;
5. multiple packets of a same stream;
6. multiple packets of different streams; where
   for example, different streams include different streams of a same UE, or different streams of different UEs;
7. multiple packets of a same QoS flow;
8. multiple packets of different QoS flows;
9. multiple packets in a same IP or UDP packet;
10. multiple packets in different IP or UDP packets;
11. multiple packets in a same burst;
12. multiple packets in different bursts;
13. multiple packets in a same bearer;
14. multiple packets in different bearers;
15. multiple packets in a same PDU session;
16. multiple packets in different PDU sessions;
17. multiple packets in a same PDU set;
18. multiple packets in different PDU sets;
19. multiple packets in a same PDU;
20. multiple packets in different PDUs;
21. multiple packets in a same DRB;
22. multiple packets in different DRBs;
23. multiple packets in a same service; and
24. multiple packets in different services.

The apparatus provided in this embodiment of this application can implement the processes implemented by the method embodiment in FIG. 6, with the same technical effects achieved. To avoid repetition, details are not described herein.

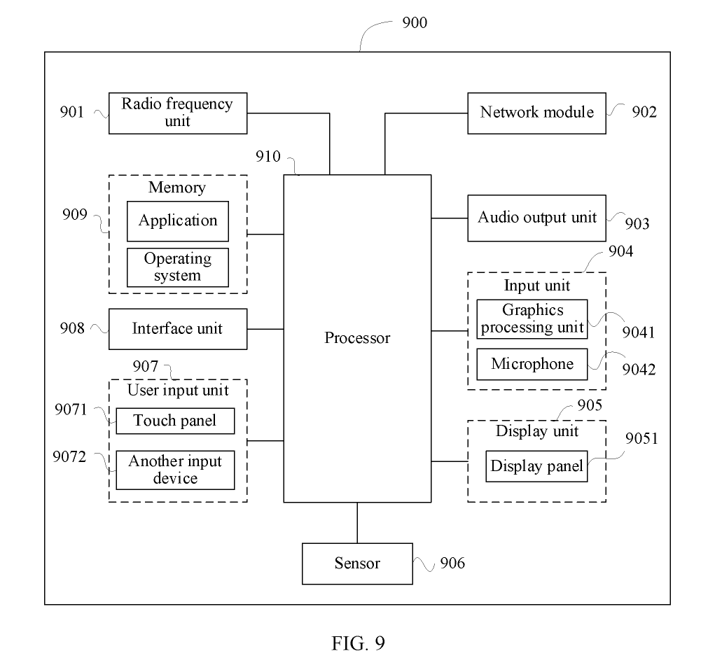

FIG. 9 is a schematic diagram of a hardware structure of a terminal implementing an embodiment of this application. The terminal 900 includes but is not limited to at least some components among a radio frequency unit 901, a network module 902, an audio output unit 903, an input unit 904, a sensor 906, a display unit 905, a user input unit 907, an interface unit 908, a memory 909, a processor 910, and the like.

Those skilled in the art can understand that the terminal 900 may further include a power supply (such as a battery) for supplying power to the components, and the power supply may be logically connected to the processor 910 through a power management system, thereby implementing functions such as charge, discharge, and power consumption management through a power management system. The terminal structure shown in FIG. 9 does not constitute a limitation on the terminal. The terminal may include more or fewer components than illustrated, or certain components may be combined, or the components may be arranged differently. Details are not described herein.

It should be understood that, in this embodiment of this application, the input unit 904 may include a graphics processing unit (GPU) 9041 and a microphone 9042. The graphics processing unit 9041 processes image data of static pictures or videos obtained by an image capture apparatus (such as a camera) in a video capture mode or an image capture mode. The display unit 905 may include a display panel 9051, and the display panel 9051 may be configured in the form of a liquid crystal display, an organic light-emitting diode, or the like. The user input unit 907 includes at least one of a touch panel 9071 and another input device 9072. The touch panel 9071 is also referred to as a touch screen, and the touch panel 9071 may include two parts: a touch detection apparatus and a touch controller. The another input device 9072 may include but is not limited to a physical keyboard, a function key (such as a volume control key or a switch key), a trackball, a mouse, a joystick, and the like. Details are not described herein.

In this embodiment of this application, after receiving downlink data from a network-side device, the radio frequency unit 901 may transmit it to the processor 910 for processing; in addition, the radio frequency unit 901 may send uplink data to the network-side device. Generally, the radio frequency unit 901 includes but is not limited to an antenna, an amplifier, a transceiver, a coupler, a low noise amplifier, a duplexer, or the like.

The memory 909 may be configured to store a software program, an instruction, and various data. The memory 909 may mainly include a first storage area storing a program or instructions and a second storage area storing data, where the first storage area may store an operating system, an application or an instruction required for at least one function (such as a sound play function or an image play function), and the like. In addition, the memory 909 may include a volatile memory or a non-volatile memory, or the memory 909 may include non-transitory memory. The non-volatile memory or non-transitory memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and memories any other suitable types.

The processor 910 may include one or more processing units; optionally, the processor 910 integrates an application processor and a modem processor, where the application processor mainly processes operations involving the operating system, user interfaces, and applications, and the modem processor mainly processes wireless communication signals, for example, may be a baseband processor. It can be understood that the above modem processor may not be integrated into the processor 910.

The terminal provided in this embodiment of this application can implement the processes implemented by the method embodiment in FIG. 5 or FIG. 6, with the same technical effects achieved. To avoid repetition, details are not described herein.

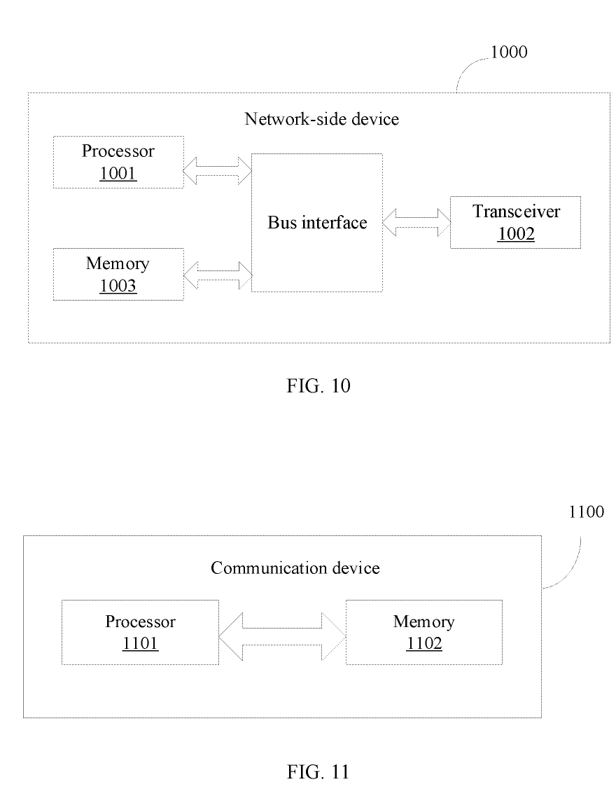

Refer to FIG. 10. FIG. 10 is a diagram of a structure of a network-side device to which an embodiment of the present invention is applied. As shown in FIG. 10, a network-side device 1000 includes: a processor 1001, a transceiver 1002, a memory 1003, and a bus interface, where the processor 1001 may be responsible for managing the bus architecture and general processing. The memory 1003 may store data used by the processor 1001 during operation execution.

In an embodiment of the present invention, the network-side device 1000 further includes: a program stored in the memory 1003 and runnable on the processor 1001. When the program is executed by the processor 1001, the steps in the method shown in FIG. 5 or FIG. 6 above are implemented.

In FIG. 10, the bus architecture may include any number of interconnected buses and bridges, specifically, various circuits of one or more processors represented by the processor 1001 and the memory represented by the memory 1003 are linked. The bus architecture may also link various other circuits of peripheral devices, voltage regulators, power management circuits, and the like, which are all well known in the art, and therefore, are not further described herein. The bus interface provides an interface. The transceiver 1002 may be multiple elements, that is, including a transmitter and a receiver, providing units for communicating with various other apparatuses over a transmission medium.

Refer to FIG. 11. FIG. 11 is a diagram of a structure of a communication device to which an embodiment of the present invention is applied. The communication device may be a first element or a second element.

As shown in FIG. 11, an embodiment of this application further provides a communication device 1100, including a processor 1101 and a memory 1102. A program or instructions runnable on the processor 1101 is stored in the memory 1102. For example, when the communication device 1100 is a sending end, and the program or the instructions are executed by the processor 1101, the steps of the method embodiment in FIG. 5 above are implemented; when the communication device 1100 is a receiving end, and the program or the instructions are executed by the processor 1101, the steps of the method embodiment in FIG. 6 above are implemented, with the same technical effects achieved. To avoid repetition, details are not described herein.

An embodiment of this application further provides a readable storage medium, where the readable storage medium stores a program or instructions. When the program or instruction is executed by a processor, the processes of the method in FIG. 5 or FIG. 6 and the embodiments described above are implemented, with the same technical effects achieved. To avoid repetition, details are not described herein.

The processor is a processor in the terminal or network-side device described in the above embodiments. The readable storage medium includes a computer-readable storage medium, such as a computer read-only memory ROM, random access memory RAM, magnetic disk, or optical disc. In some embodiments, the readable storage medium may be a non-transitory readable storage medium.

An embodiment of this application further provides a chip, where the chip includes a processor and a communication interface, the communication interface and the processor are coupled with each other, and the processor is configured to run a program or instructions to implement the processes of the method embodiments shown in FIG. 5 or FIG. 6 and in the above descriptions, with the same technical effects achieved. To avoid repetition, details are not described herein.

It should be understood that the chip in the embodiments of this application may also be referred to as a system on chip, system on a chip, system-on-chip, SoC, or the like.

An embodiment of this application further provides a computer program/program product, where the computer program/program product is stored in a storage medium, and the computer program/program product is executed by at least one processor to implement the processes of the method embodiments shown in FIG. 5 or FIG. 6 and in the above descriptions, with the same technical effects achieved. To avoid repetition, details are not described herein.

An embodiment of this application further provides a communication system, where the communication system includes a terminal and a network-side device, the terminal is configured to perform the processes of the method embodiments in FIG. 5 and in the above descriptions, and the network-side device is configured to perform the processes of the method embodiments in FIG. 6 and in the above descriptions, with the same technical effects achieved. To avoid repetition, details are not described herein.

It should be noted that, in this specification, the terms "include", "comprise" or any other variant thereof is intended to cover non-exclusive inclusion, such that a process, method, article, or apparatus that includes a series of elements not only includes those elements, but also includes other elements not explicitly listed, or elements inherent to such process, method, article, or apparatus. Without further limitation, an element defined by the statement "including a…" does not exclude the presence of additional identical elements in the process, method, article, or apparatus that includes the element. In addition, it should be noted that the scope of the methods and apparatuses in the embodiments of this application is not limited to performing functions in the order shown or discussed, and may alternatively perform functions substantially simultaneously or in reverse order based on the involved functions, for example, the described methods may be performed in an order different from that described, and various steps may also be added, omitted, or combined. In addition, features described with reference to certain examples may be combined in other examples.

Through the description of the above embodiments, those skilled in the art can clearly understand that the method of the above embodiments can be implemented by means of a computer software product on a necessary general hardware platform, and certainly can also be implemented by hardware. The computer software product is stored in a storage medium (such as an ROM, RAM, magnetic disk, or optical disc), and includes several instructions for enabling a terminal or a network-side device to execute the methods described in the embodiments of this application.

The embodiments of this application have been described above with reference to the accompanying drawings, but this application is not limited to the specific embodiments described above. The specific embodiments described above are merely illustrative rather than limitative. Those of ordinary skill in the art can devise many forms of embodiments under the inspiration of this application, without departing from the purpose and scope protected by the claims of this application, and these embodiments all fall within the protection scope of this application.

What is claimed is:

1. A communication processing method, comprising:
receiving, by a first element, first information from a second element, wherein the first information is related to coordination or synchronization between streams; and
performing, by the first element, a first operation based on the first information; wherein
the first element is a first node and the second element is a second node, or the first element is a first entity and the second element is a second entity.

2. The method according to claim 1, wherein the performing a first operation comprises at least one of the following:
mapping a stream to a corresponding quality of service flow (QoS flow);
mapping a stream or a QoS flow to a corresponding data radio bearer (DRB);
mapping a stream or a QoS flow or a DRB to a corresponding radio bearer;
mapping a stream or a QoS flow or a DRB or a bearer to a corresponding logic channel group (LCG);
mapping a stream or a QoS flow or a DRB or a bearer to a corresponding logic channel prioritization (LCP);
mapping a stream or a QoS flow or a DRB or a bearer to a corresponding logic channel (LCH); or
applying a corresponding discard timer (discardTimer).

3. The method according to claim 1, wherein the receiving, by a first element, first information from a second element comprises:
in a case that a first condition is satisfied, receiving, by the first element, the first information from the second element; wherein
the first condition comprises at least one of the following:
a first requirement is not satisfied between packets or streams;
a second requirement is not satisfied between two nodes or two entities;
a third requirement is not satisfied between packets or streams of two nodes, or between packets or streams of two entities; or
a delay difference between packets or streams is greater than or equal to a first threshold; wherein
the first requirement or the second requirement or the third requirement comprises at least one of the following: a synchronization requirement or a coordination requirement; or,
wherein the performing, by the first element, a first operation based on the first information comprises:
in a case that a second condition is satisfied, performing, by the first element, the first operation based on the first information; wherein
the second condition comprises at least one of the following:
a fourth requirement is not satisfied between packets or streams;
a fifth requirement is not satisfied between two nodes or two entities;
a sixth requirement is not satisfied between packets or streams of two nodes, or between packets or streams of two entities; or
a delay difference between packets or streams is greater than or equal to a second threshold; wherein
the fourth requirement or the fifth requirement or the sixth requirement comprises at least one of the following: a synchronization requirement or a coordination requirement.

4. The method according to claim 1, wherein the receiving, by a first element, first information from a second element comprises at least one of the following:
receiving, by the first node, the first information from the second node directly; or
receiving, by the first node, the first information from the second node through a third node; or,
wherein the receiving, by a first element, first information from a second element comprises at least one of the following:
receiving, by the first entity, the first information from the second entity directly; or
receiving, by the first entity, the first information from the second entity through a third entity.

5. The method according to claim 1, wherein the first node and the second node comprise at least one of the following:
two nodes having a synchronization requirement or a coordination requirement; or
two nodes which two objects having a synchronization requirement or a coordination requirement are located in or belong to; or,
wherein the first entity and the second entity comprise at least one of the following:
two entities having a synchronization requirement or a coordination requirement; or
two entities for two objects having a synchronization requirement or a coordination requirement, where the two objects are located in, or mapped to, or correspond to the two entities.

6. The method according to claim 5, wherein the object comprises at least one of the following: a service stream, a protocol data unit (PDU) session, a bearer, a stream, a QoS flow, a DRB, a radio link control (RLC) bearer, an LCG, an LCH, a PDU set, a PDU, or a packet.

7. The method according to claim 1, wherein the first entity and the second entity correspond to a same node, or the first entity and the second entity correspond to different nodes.

8. The method according to claim 1, wherein the first information comprises at least one of the following:
whether a seventh requirement is satisfied between packets or streams or nodes or entities;
synchronization or coordination object information;
a synchronization indicator or a coordination indicator;
a synchronization requirement;
a coordination requirement;
a time label or a timestamp;
a synchronization requirement between packets;
a synchronization requirement between streams;
a delay requirement for packets that have an association relationship or an eighth requirement; or
a delay requirement for streams that have an association relationship or a ninth requirement; wherein
the seventh requirement or the eighth requirement or the ninth requirement comprises at least one of a synchronization requirement or a coordination requirement;
wherein whether a synchronization requirement is satisfied between packets comprises: whether a delay difference between the packets is less than or equal to a third threshold;
or
whether a synchronization requirement is satisfied between streams comprises: whether a delay difference between the streams is less than or equal to a fourth threshold.

9. The method according to claim 3, wherein the node comprises at least one of the following: a terminal, a user, or a network-side node.

10. The method according to claim 4, wherein in a case that the first node is a first terminal and the second node is a second terminal, or the first node is a first client and the second node is a second client, the third node comprises at least one of the following: a terminal or a client other than the first node and the second node, a network-side node, or a server;
or
in a case that the first node is a first network-side node and the second node is a second network-side node, the third node comprises at least one of the following: a network-side node other than the first node and the second node, a terminal, or a server.

11. The method according to claim 3, wherein the entity comprises at least one of the following: a service data adaptation protocol (SDAP) entity, a packet data convergence protocol (PDCP) entity, an RLC entity, a medium access control (MAC) entity, or a physical (PHY) layer entity.

12. The method according to claim 4, wherein in a case that the first entity is a first SDAP entity and the second entity is a second SDAP entity, the third entity comprises at least one of the following: a PDCP entity or a radio resource control (RRC) entity;
or
in a case that the first entity is a first PDCP entity and the second entity is a second PDCP entity, the third entity comprises at least one of the following: an SDAP entity, an RLC entity, a MAC entity, or an RRC entity;
or
in a case that the first entity is a first RLC entity and the second entity is a second RLC entity, the third entity comprises at least one of the following: an SDAP entity, a PDCP entity, a MAC entity, or an RRC entity;
or
in a case that the first entity is a first MAC entity and the second entity is a second MAC entity, the third entity comprises at least one of the following: a PDCP entity, an RLC entity, a PHY entity, or an RRC entity.

13. The method according to claim 3, wherein the packet comprises:
multiple packets of a same user;
multiple packets of different users;
multiple packets of a same terminal;
multiple packets of different terminals;
multiple packets of a same stream;
multiple packets of different streams;
multiple packets of a same QoS flow;
multiple packets of different QoS flows;
multiple packets in a same IP or user datagram protocol (UDP) packet;
multiple packets in different IP or UDP packets;
multiple packets in a same burst;
multiple packets in different bursts;
multiple packets in a same bearer;
multiple packets in different bearers;
multiple packets in a same PDU session;
multiple packets in different PDU sessions;
multiple packets in a same PDU set;
multiple packets in different PDU sets;
multiple packets in a same PDU;
multiple packets in different PDUs;
multiple packets in a same DRB;
multiple packets in different DRBs;
multiple packets in a same service; and
multiple packets in different services.

14. A communication processing method, comprising:
sending, by a second element, first information to a first element, wherein the first information is related to coordination or synchronization between streams; wherein
the first information is used for the first element to perform a first operation; and
the first element is a first node and the second element is a second node, or the first element is a first entity and the second element is a second entity.

15. The method according to claim 14, wherein the performing a first operation comprises at least one of the following:
mapping a stream to a corresponding QoS flow;
mapping a stream or a QoS flow to a corresponding DRB;
mapping a stream or a QoS flow or a DRB to a corresponding bearer;
mapping a stream or a QoS flow or a DRB or a bearer to a corresponding LCG;
mapping a stream or a QoS flow or a DRB or a bearer to a corresponding LCP;
mapping a stream or a QoS flow or a DRB or a bearer to a corresponding LCH; or
applying a corresponding discardTimer.

16. The method according to claim 14, wherein the sending, by a second element, first information to a first element comprises:
in a case that a first condition is satisfied, sending, by the second element, the first information to the first element; wherein
the first condition comprises at least one of the following:
a first requirement is not satisfied between packets or streams;
a second requirement is not satisfied between two nodes or two entities;
a third requirement is not satisfied between packets or streams of two nodes, or between packets or streams of two entities; or
a delay difference between packets or streams is greater than or equal to a first threshold; wherein
the first requirement or the second requirement or the third requirement comprises at least one of the following: a synchronization requirement or a coordination requirement.

17. The method according to claim 14, wherein the sending, by a second element, first information to a first element comprises at least one of the following:
sending, by the second node, the first information to the first node directly; or
sending, by the second node, the first information to the first node through a third node; or,
wherein the sending, by a second element, first information to a first element comprises at least one of the following:
sending, by the second entity, the first information to the first entity directly; or
sending, by the second entity, the first information to the first entity through a third entity.

18. The method according to claim 14, wherein the first node and the second node comprise at least one of the following:
two nodes having a synchronization requirement or a coordination requirement; or
two nodes which two objects having a synchronization requirement or a coordination requirement are located in or belong to; or,
wherein the first entity and the second entity comprise at least one of the following:
two entities having a synchronization requirement or a coordination requirement; or
two entities for two objects having a synchronization requirement or a coordination requirement, where the two objects are located in, or mapped to, or correspond to the two entities.

19. A communication device, applied to a first element, comprising a processor, a memory, and a program or instructions stored in the memory and executable on the processor, wherein the program or the instructions, when executed by the processor, cause the communication device to perform:
receiving first information from a second element, wherein the first information is related to coordination or synchronization between streams; and
performing a first operation based on the first information; wherein
the first element is a first node and the second element is a second node, or the first element is a first entity and the second element is a second entity.

20. A communication device, comprising a processor, a memory, and a program or instructions stored in the memory and executable on the processor, wherein when the program or the instructions are executed by the processor, the steps of the method according to claim 14 are implemented.
